(19) United States
(12) Patent Application Publication
(10) Pub. No.: US 2005/0254229 A1
(43) Pub. Date: Nov. 17, 2005

(54) I-light

(76) Inventors: Ali Hamade, Edgewater, NJ (US); Amanda Pohan, Edgewater, NJ (US)

Correspondence Address: Amanda Pohan, 314 TOWER DRIVE, EDGEWATER, NJ, 07020, US

(21) Appl. No.: 10/846,857

(22) Filed: May 17, 2004

(51) Int. Cl. F21V 21/08

(52) U.S. Cl. 362/103

(57) ABSTRACT

The I-Light is a symbol of the future. I-Light stands for distinctiveness, uniqueness, practicality, style, functionality, genius and a symbol of the modern world. The I-Light is a powerful long-lasting flashlight, watch, compass, and GPS tracking device all combined into one small and sleek fusion of rubber, glass and titanium that is worn on the wrist like a watch. A flashlight cannot accomplish all of these things, and even if it could, it would still be a burden because it would be yet another object that you have to drag around with you. A flashlight that is worn on the head with a strap is not at all attractive or practical, and does not include the other features that I-Light has. The I-Light frees you from worrying about losing your flashlight or lugging it around. The I-Light is an exceptional and unique invention that has never been attempted before. The I-Light is unique, perfect, and practical, and we guarantee that it is truly one of a kind.

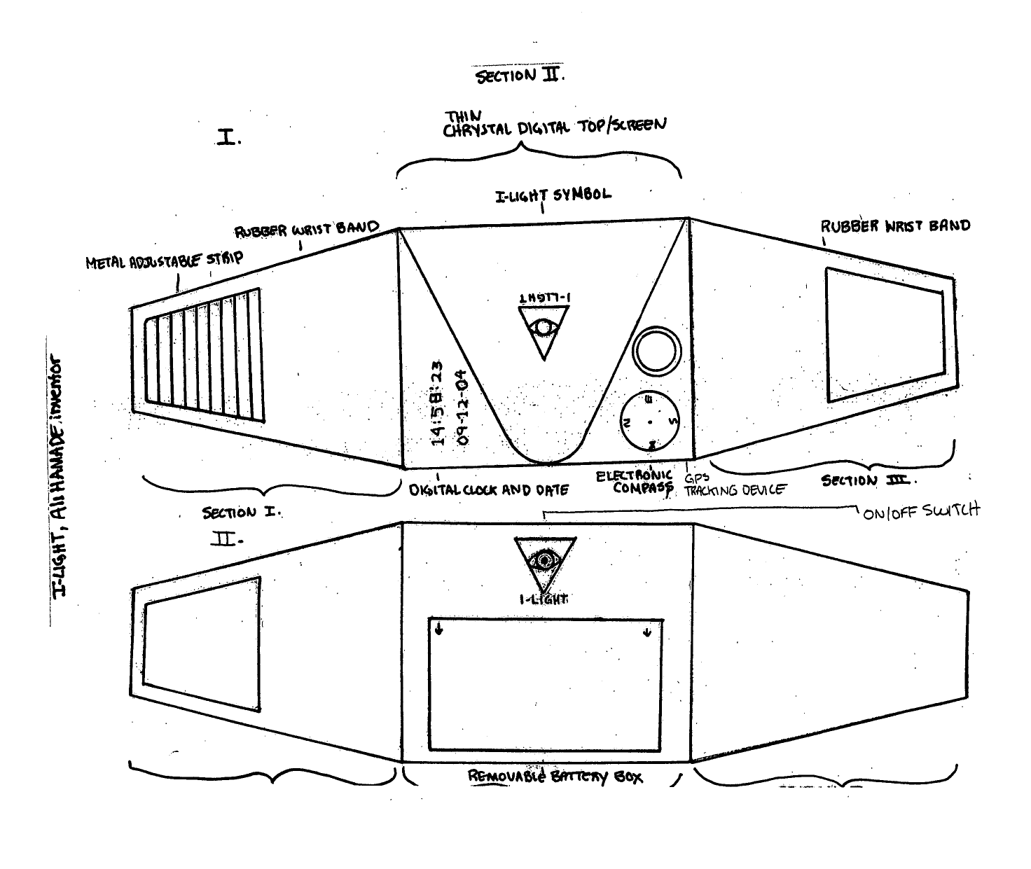

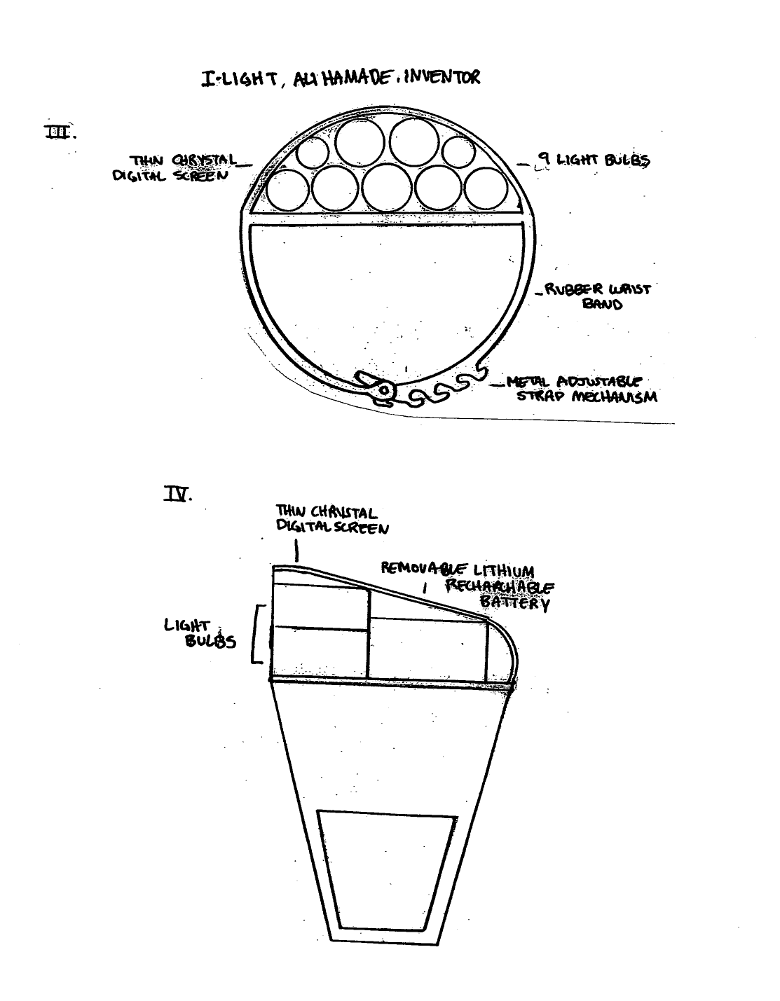

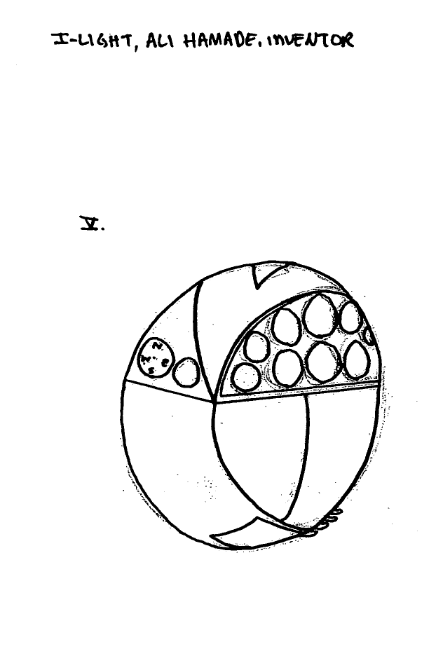

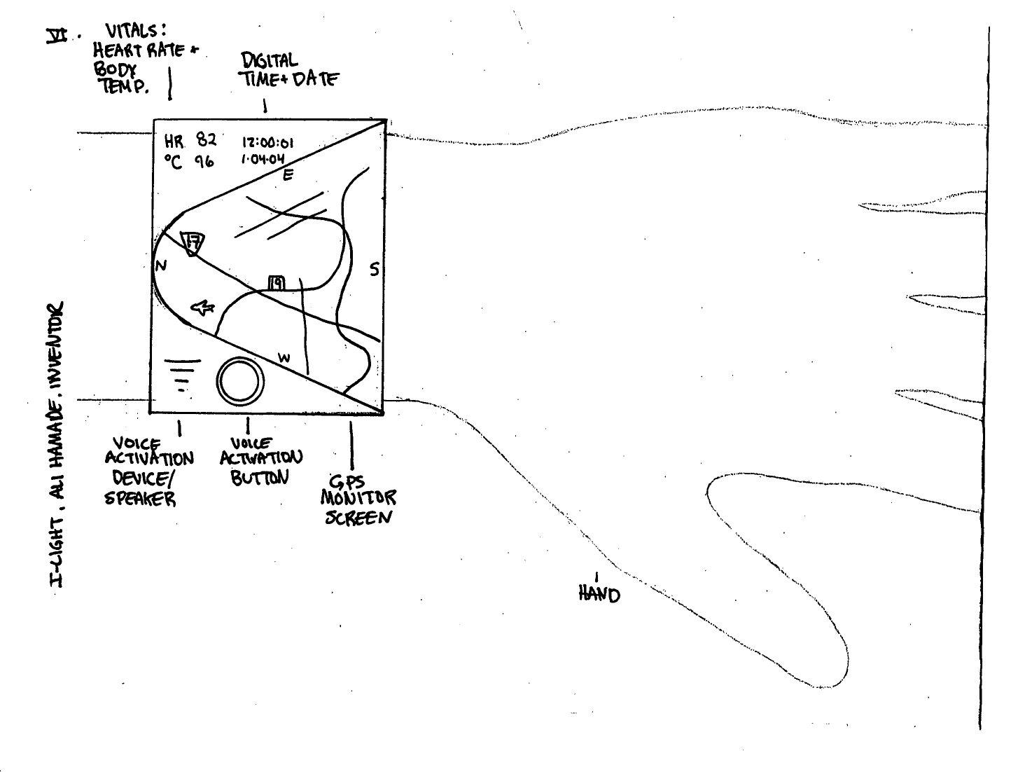

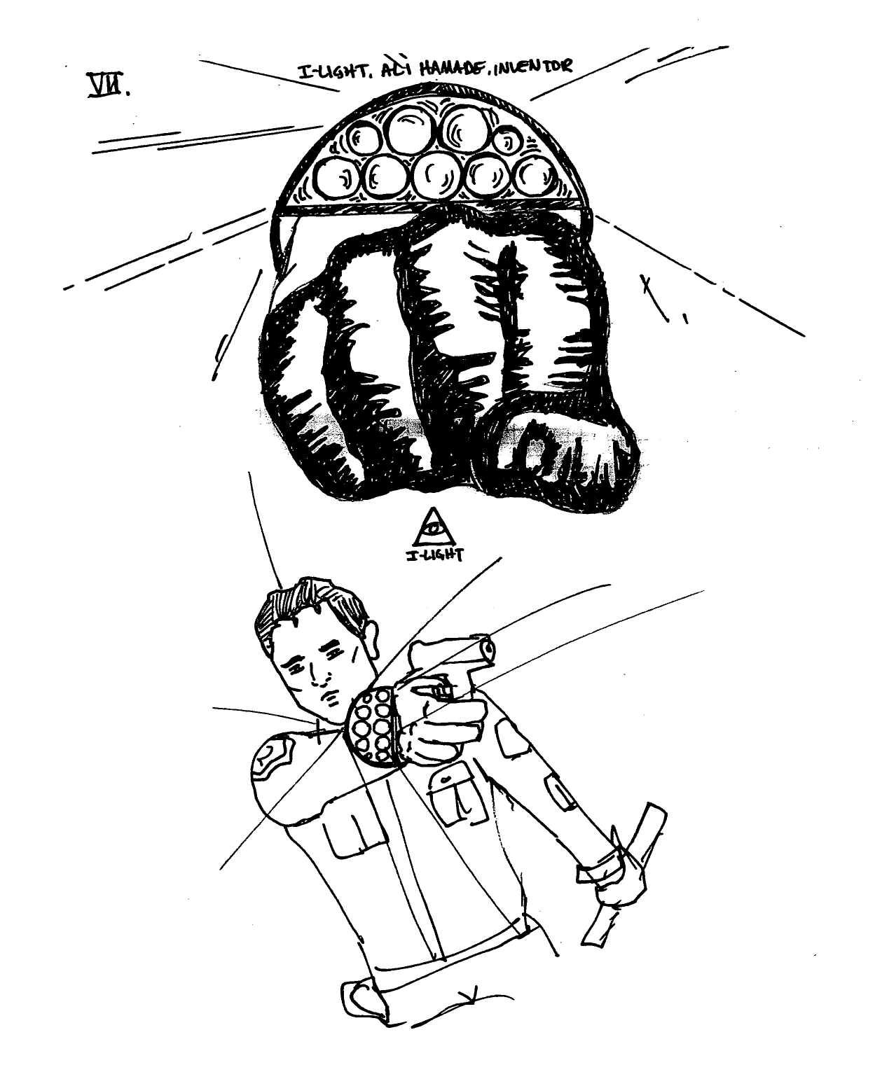

U.S. Pat. Classification No. 362, titled Illumination, subclass 8, number 103, “for an illuminator combined with wearing apparel and may include a battery”. The I-Light is a wearable illuminating device, like a flashlight, but worn on the wrist, and its variations include a GPS device and screen, watch, vital signs, stopwatch, compass, video and picture camera.

### FIELD OF INVENTION

### STATEMENT OF THE OBJECT OF THE INVENTION

The I-Light is a light that is worn on the wrist and adjustable for size. The object or purpose of the I-Light is to aid police officers, US soldiers, hikers, divers, and any individual to have an illuminating device that is worn on the wrist, giving the ability to point and shine it on any object at will, instead of having to carry a flashlight, allowing both hands free to fully function. The I-Light enables the officer or soldier to use his or her wrist to illuminate anyone or anything in place of using a flashlight, and still have either his or her hands free to function simultaneously, as well as replacing the need to carry a flashlight when in a compromising or tense situation that needs full participation and awareness. The I-Light is also of particular benefit to hikers, divers, or those who do extreme physical activities so that he or she can have the benefits of a flashlight and have both hands free to function. The object of the I-light is to make it easier for an individual who needs both an illuminating device and both hands free to work. The I-Light also includes the options of having a compass, GPS tracking device and screen, picture and video camera, voice activated emergency call system, vital signs, and stopwatch, so that it can accommodate the needs of every individual. Besides being of particular benefit to officers of the law and soldiers, the I-light can be used by the average Joe when he takes a jog at night, cleans out the garage or closet, when he goes camping, or as a fun toy for kids and young adults to enjoy.

### BRIEF DESCRIPTION OF THE SEVERAL VIEWS OF THE DRAWINGS

I. Plan View of the Top Side of I-Light
Sections 1 and 3 are the rubber bands of the I-Light that clasp together on the wrist, and section 2 sits on the top part of the wrist. Section 1 has 5 metal raised jagged edges, as described in plan as vertical lines. The metal hook as seen in section 3 hooks onto any one of those raised edges to create the adjustable notches on the band for various sizes. Section 2, the top part of the I-Light, which is dome-like in three-dimensions, holds digital time and date, digital compass, a GPS tracking device, and the I-Light symbol in the middle. The digital features are displayed on a thin crystal digital screen.

II. Plan View of the Underside of the I-Light
The triangular I-Light symbol is the on/off switch for the light bulbs. The button is activated by moving the wrist down so that the fingers of the hand point downwards towards the ground, thus moving the top part of the wrist upwards so that it pushes on the switch and activates the lights. The same motion is applied to turn the lights off. Section 2 also has a rectangular box, which is the removable battery box. The rectangular thin piece is made of metal. By sliding the piece down and off, the battery inside is exposed. The lithium battery can then be lifted out, and either replaced or charged on a charger that is electrically powered.

III. Section View
The top half of this drawing exposes the 9 LED light bulbs, the titanium shell that holds the lights, and the thin crystal digital screen that sits on top of the shell. The lower half of the drawing describes the adjustable strap mechanism and the rubber band.

IV. Elevation View
The elevation drawing shows the light bulbs and battery contained within the dome structure of the top part of the I-Light. The lower half of the drawing shows the band and the hook on the band of the I-Light.

V. Perspective
The perspective view shoes the lights contained within the dome-shaped top, as well as the compass, GPS device, band, and adjustable band mechanism.

VI. Plan
This view shows additional features that the I-Light can come with. It comes with the option of adding a voice activated emergency call system, a full GPS system with a screen to see your precise location, vital signs, including heart rate and body temperature, digital compass and clock, and a video and picture camera which would be in place of two of the light bulbs.

VII. These two drawings show the I-Light as it is worn on the wrist.

### DESCRIPTION OF PREFERRED EMBODIMENT

The I-Light, an adjustable wrist wearable light has never been invented or attempted before. The I-Light fits on the wrist like a watch, and is of comparable size and appearance. I-Light has a raised dome-like triangular piece on the top, which holds 9 very powerful and energy efficient light bulbs that point away from the hand. This enables an individual to simply press the button on the underside of the I-Light by using his or her wrist and illuminate any object without having to carry a clunky flashlight, and enables the individual to have two free hands. The I-Light is made of a titanium shell so that it is lightweight, durable, and waterproof. The I-Light contains 9 LED light bulbs with a rechargeable battery underneath. On the top part of the I-Light is a thin crystal digital screen to display that various options, including a GPS tracking screen, vital signs and the digital sate and time. Two light bulbs can be replaced with a video and photo camera.

1. What we claim as our invention is that the I-Light is entirely unique and distinguished from any other illuminating device or object that has ever been created or attempted by man. The I-Light is wearable light worn on the wrist made with a lightweight titanium shell, digital glass screen, and rubber wristband. It holds advanced LED light bulbs powered by a small rechargeable lithium battery underneath. I-Light is powerful, durable, waterproof, long lasting, shock-absorbent, and most importantly allows the individual full use of his or her hands while still having the benefits of using a powerful flashlight. It also comes with the option of functioning not only as an illuminating device, but as a watch, compass, GPS tracking device, video and picture camera, voice activated emergency call system, and monitors vital signs so that it is in fact a multi-functional flashlight, which is of particular use to police officers and soldiers and those who do extreme activities. The I-Light does more than a flashlight, more than a light that you wear on your head or keep on your keychain, more than a watch or GPS device alone. It is so original and modem that it caters to many different walks of life and many different needs. The I-Light is so innovative, practical, stylish, and unique, that we should be awarded protection for its distinctiveness and perfect genius under the United States patent laws.
